(19) United States
(12) Patent Application Publication
(10) Pub. No.: US 2005/0170674 A1
(43) Pub. Date: Aug. 4, 2005

(54) Socket connector

(76) Inventor: Yao Pang Lu, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/025,143

(22) Filed: Dec. 28, 2004

(30) Foreign Application Priority Data
Jan. 30, 2004 (TW) 93201382

(51) Int. Cl. H01R 12/00

(52) U.S. Cl. 439/66

(57) ABSTRACT

A socket connector (100) includes an insulative housing (1) and a number of contacts (8). The insulative housing has a bottom surface (15), and defines a number of passageways (16) extending through a bottom surface thereof. The contacts are respectively received in the number of passageways. Each contact is formed with a holding portion (22) engaging with the insulative housing. A soldering portion (26) extends from the holding portion. A contacting portion (29) extends from the soldering portion. The soldering portion has a pair of positioning portion (25) laterally extending from side edges thereof and abutting against the bottom surface.

### BACKGROUND OF THE INVENTION

1. Field of the Invention

The present invention relates to a socket connector, and particularly to a socket connector used in the mobile phones or other electronic equipments.

2. Description of the Prior Art

Because the requirements of the customer become more and more higher, personal electronic consumer productions, such as mobile phones and Personal Digital Assistants (PDAs), are designed to comply with the miniaturization trend, which is also the requirement of the customer. As a result, the requirement of socket connectors used in such equipments is correspondingly enhanced.

A conventional contact 8 used in a conventional socket connector, which employs a Surface Mounting Technology (SMT), is shown in FIG. 5. Such a socket contact is used to electrically connect a chip (not shown) and a Printed Circuit Board (PCB, not shown). The contact 8 has a U-shaped holding portion 81, a soldering portion 83 for connecting to the PCB via a solder ball (not shown) and an extending portion 82 connecting with the holding portion 81 and the soldering portion 83. The contact 8 has a connecting portion 84 upwardly extending from the soldering portion 83 and a contacting portion 85 upwardly and rearwardly bent from the connecting portion 84. The contacting portion 85 is to be contact with a corresponding pin of a chip. The contact 8 also has a pair of positioning portions 86 symmetrically and upwardly extending from the soldering portion 83. The positioning portions 86 are two tabs in fact, which are parallel to the connecting portion 84 and spaced from the connecting portion 84.

When the contacts 8 are assembled to an insulative housing of the socket connector, the positioning portions 86 are secured with the insulative housing. The recess portions 861 abut on corresponding portions formed in the insulative housing to enable the soldering portions 83 be coplanar. However, as the positioning portions 86 are difficult to be designed symmetrically, it may be very difficult to ensure the coplanarity of the soldering portions 83. When such contacts 8 are used in some miniature equipments, this problem may even be worse.

Hence, an improved socket connector is required to overcome the disadvantages of the prior art.

### SUMMARY OF THE INVENTION

An object of the present invention is to provide a socket connector having a plurality of contacts, the contacts having soldering portions with good performance in coplanarity.

In order to achieve the aforementioned object, the socket connector in according with the present invention comprises an insulative housing and a plurality of contacts. The insulative housing defines a plurality of passageways. The contacts are respectively received in the plurality of passageways. Each contact has a holding portion engaging with the insulative housing, a soldering portion for soldering to a printed circuit board and a contacting portion for connecting to a complementary element. The soldering portion is provided with a pair of positioning portions laterally extending from side edges thereof and abutting against the housing.

The insulative housing also has a top surface and a bottom surface, and the passageways extending through the top and the bottom surfaces. The positioning portions abut against the bottom surface.

The positioning portion in the present invention is a tab laterally and horizontally extending from the soldering portion. As the positioning portion is coplanar with the soldering portion and abuts against a bottom surface of the insulative housing, it is easy to ensure the soldering portions in a common plane.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an exploded perspective view of a socket connector in accordance with the invention;

FIG. 2 is an assembled perspective view of the socket connector in FIG. 1 showing a bottom surface;

FIG. 3 is a cross-sectional view taken along line 3-3 in FIG. 2;

FIG. 4 is an enlarged perspective view of a contact in FIG. 1; and

FIG. 5 is a perspective view of a conventional contact.

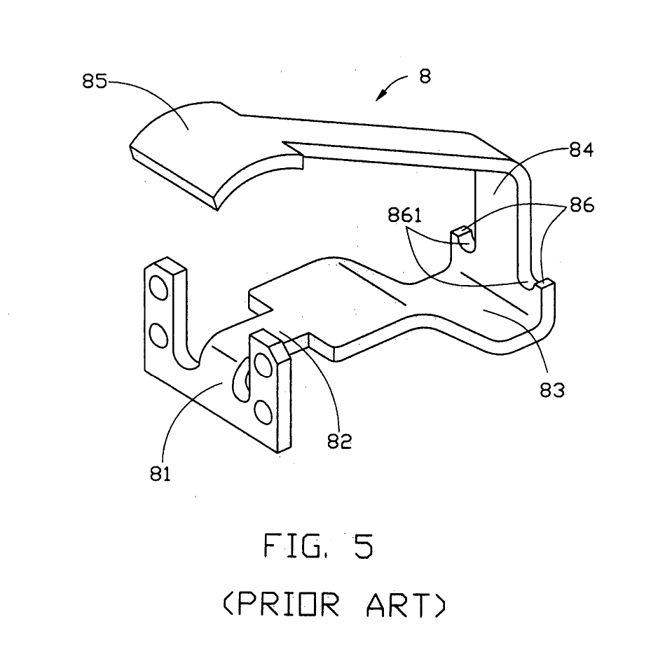

### DETAILED DESCRIPTION OF THE PREFERRED EMBODIMENTS

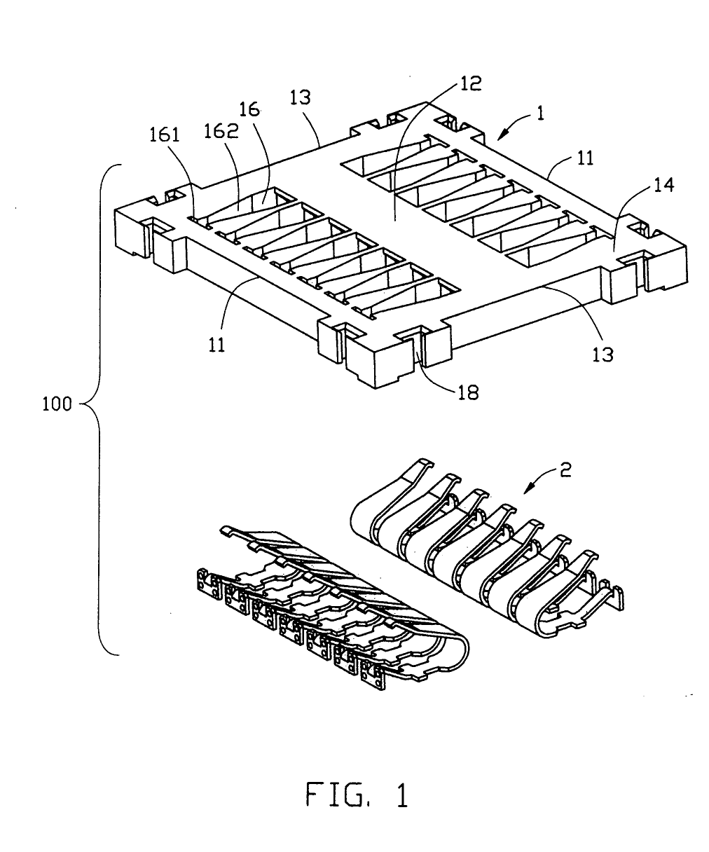

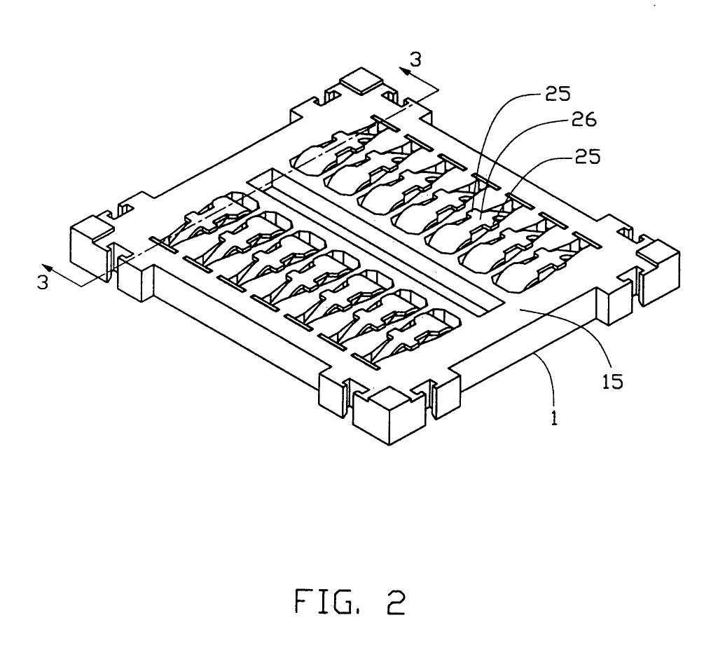

Referring to FIGS. 1 and 2, a socket connector 100 in accordance with the present invention comprises an insulative housing 1 and a plurality of contacts 2.

The insulative housing 1 comprises opposite side walls 11, opposite end walls 13 respectively perpendicular to the side walls 11 and a central wall 12 parallel to the side walls 11 and connecting with central portions of the end walls 13. The insulative housing 1 is symmetrical with the central wall 12. The insulative housing 1 has a top surface 14 and a bottom surface 15. A plurality of passageways 16 is defined through the top surface 14 and the bottom surface 15 in the insulative housing 1. The passageways 16 are arranged in two rows and are symmetrical with the central wall 12. Each passageway 16 has a slit 161 located adjacent to a corresponding side wall 11, and a receiving groove 162 extending in a direction perpendicular to the slit 161 and towards the central wall 12. The insulative housing 1 has a plurality of retaining troughs 18 defined at opposite ends of the opposite side walls 11 and the end walls 13.

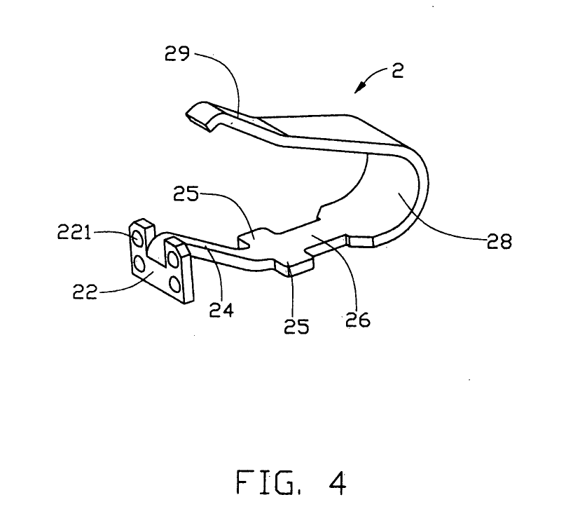

Referring to FIGS. 2 and 4, the contacts 2 are made of conductive material. Each contact 2 includes a U-shaped holding portion 22. The holding portion 22 is formed with a plurality of semi-spherical protrusions 221 projecting from a side face (not labeled) thereof. An extending portion 24 laterally extends from a central portion of the holding portion 22. A soldering portion 26 extends from one end of the extending portion 24 in a direction away from the holding portion 22. A curved portion 28 is bent upwardly and backwardly from the soldering portion 26. A contacting portion 29 is formed at a free end of the curved portion 28. The soldering portion 26 comprises a pair of positioning portions 25 laterally and horizontally extending from a portion adjacent to the extending portion 24 (best shown in FIG. 4). The positioning portions 25 are symmetrical with the soldering portion 26 and each has a thickness the same as the soldering portion 26.

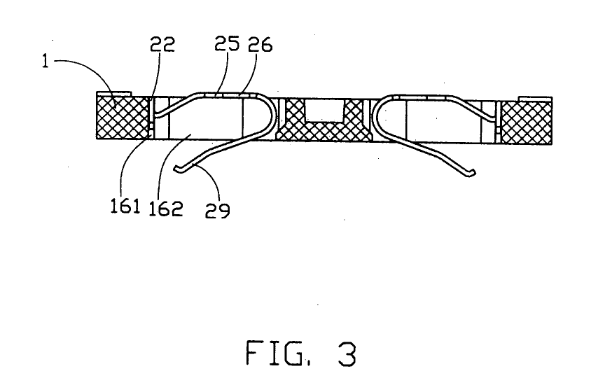

Referring to FIG. 3 in conjunction with FIGS. 1 and 2, in assembly, the contacts 2 are inserted to the passageways 16 in a bottom-to-top direction, of which the holding portions 22 are inserted into the slits 161. The protrusions 221 of the holding portions 22 have an interference fit with inner faces of the slits 161, thereby securing the contacts in the passageways 16. As is described above, the extending portion 24 extends from the holding portion 22 and bends toward the holding portion 24. When the positioning portion 25 abuts against the bottom surface 15 of the insulative housing 1, an angle between the extending portion 24 and the holding portion 22 brings in a preload for the positioning portions 25. Thus, the positioning portions 25 abut the bottom surface 15 tightly, and the positioning portions 25 are in a common plane. The soldering portions 26 are to be soldered onto a PCB (not shown). The contacting portions 29 extend beyond the top surface 14 of the housing 1 to electrically connect with other electronic element (not shown). As the positioning portions 25 horizontally extend from the soldering portions 26 and are coplanar with the soldering portions 26, and the positioning portions 25 abut the bottom surface 15, the coplanarity of the soldering portions 26 is thus achieved.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A socket connector comprising:
an insulative housing defining a plurality of passageways; and
a plurality of contacts respectively received in the plurality of passageways, each contact having a holding portion engaging with the insulative housing, a soldering portion for soldering to a printed circuit board and a contacting portion for connecting to a complementary element, the soldering portion having a pair of positioning portions laterally extending from side edges thereof and abutting against the housing.

2. The socket connector as claimed in claim 1, wherein the positioning portions each has a thickness the same as the soldering portion.

3. The socket connector as claimed in claim 1, wherein the insulative housing has a top surface and a bottom surface, and the passageways extending through the top and the bottom surfaces, the positioning portions abutting against the bottom surface.

4. The socket connector as claimed in claim 4, wherein the housing defines a slit in each passageway, and the holding portion of the contact received in the slit.

5. The socket connector as claimed in claim 1, wherein the soldering portion extends from the holding portion and the contacting portion extends upwardly and curvedly from the soldering in a first direction.

6. The socket connector as claimed in claim 5, wherein the contact comprises an extending portion extending upwardly from the soldering portion in a second direction opposite to the first direction.

7. A socket connector comprising:
an insulative housing defining opposite upper and lower surfaces with a plurality of passageways extending therethrough; and
a plurality of contacts respectively received in the plurality of passageways, each contact having a holding portion retainably engaging with the insulative housing, a soldering portion exposed around the lower surface for soldering to a printed circuit board and a contacting portion extending above the upper surface for connecting to a complementary element, wherein
the contact further defines at least one positioning portion located adjacent to the soldering portion and abutting against the lower surface.

8. The socket connector as claimed in claim 7, wherein said contacting portion and said soldering portion are connected by a moveable curved portion.

9. The socket connector as claimed in claim 8, wherein said holding portion and said curved portion are respectively located on two opposite ends of the corresponding passageway.

10. The socket connector as claimed in claim 9, wherein the passageway defines a narrowed cross-sectional dimension adjacent to said holding portion for compliance with engagement between the positioning portion and the lower surface.

11. The socket connector as claimed in claim 10, wherein said narrowed cross-sectional dimension is also tapered.
